(19) United States
(12) Patent Application Publication
(10) Pub. No.: US 2023/0215259 A1
(43) Pub. Date: Jul. 6, 2023

(54) COLLISION RISK NOTIFICATION SYSTEM

(71) Applicant: Katsunori Suetsugu, Tokyo (JP)

(72) Inventor: Katsunori Suetsugu, Tokyo (JP)

(21) Appl. No.: 18/093,152

(22) Filed: Jan. 4, 2023

(30) Foreign Application Priority Data
Jan. 5, 2022 (JP) 2022-000781

(51) Int. Cl. G08B 21/02; G08B 7/06

(52) U.S. Cl. CPC G08B 21/02; G08B 7/06

(57) ABSTRACT

In a collision risk notification system notifying a user of a risk of a collision between the user and an object outside the user, the collision risk notification system includes a distance sensor disposed on an attached portion attached to a torso of the user and detecting a distance to the object in a non-contact manner, an output execution unit, and a collision risk notification unit. The collision risk notification system includes the distance sensor for the object present in a front direction of the user and the distance sensor for the object present in a rear direction of the user, and the collision risk notification system does not include at least one of the distance sensor for the object present in a left direction of the user or the distance sensor for the object present in a right direction of the user.

### CROSS REFERENCE TO RELATED APPLICATION

This application is based upon and claims the benefit of priority from Japanese Patent Application No. 2022-000781 filed Jan. 5, 2022, the entire contents of which are incorporated herein by reference.

### BACKGROUND OF THE INVENTION

### 1. Technical Field

The present invention relates to a collision risk notification system that notifies a user of the risk of a collision between the user and an object outside the user.

### 2. Description of the Related Art

Conventionally, a white cane for causing a user to recognize the risk of a collision between the user and an object outside the user is known (see, for example, JP 2017-006182 A).

### SUMMARY OF THE INVENTION

However, only when the white cane itself comes into contact with the object outside the user, the white cane can make the user recognize the risk of a collision between the object and the user. Thus there is a problem that it is sometimes impossible to make the user recognize the risk of the collision between the user and the object outside the user.

Therefore, an object of the present invention is to provide a collision risk notification system that can improve the ability to make a user recognize the risk of a collision between the user and an object outside the user as compared with the related art.

A collision risk notification system according to the present invention includes a distance sensor that detects a distance to an object outside a user in a non-contact manner, an output execution unit that executes output to be recognized by the user by a method other than a method through vision of the user, and a collision risk notification unit that notifies the user of a risk of a collision between the user and the object, wherein the distance sensor and the output execution unit are attached to the user, and the collision risk notification unit notifies the user of the risk by output from the output execution unit in accordance with a distance detected by the distance sensor.

With this configuration, the collision risk notification system according to the present invention notifies the risk of the collision between the user and the object outside the user by the output to be recognized by the user by a method other than the method through the vision of the user in accordance with a distance to the object outside the user detected by the distance sensor in a non-contact manner, so that it is possible to improve the ability to make the user recognize the risk of the collision between the user and the object outside the user as compared with the related art.

In the collision risk notification system according to the present invention, the collision risk notification unit may notify the user of the risk in a stepwise manner by changing a mode of output from the output execution unit in a stepwise manner in accordance with a distance detected by the distance sensor, when notifying the user of the risk by the output from the output execution unit.

With this configuration, in the case of notifying the risk of the collision between the user and the object outside the user by the output to be recognized by the user by a method other than the method through the vision of the user, the collision risk notification system according to the present invention notifies the user of the risk of the collision between the user and the object outside the user in a stepwise manner by changing the mode of output to be recognized by the user by a method other than the method through the vision of the user in a stepwise manner in accordance with a distance detected by the distance sensor, so that it is possible to make the user recognize in a stepwise manner the risk of the collision between the user and the object outside the user.

In the collision risk notification system according to the present invention, in a case where the collision risk notification unit notifies the user of the risk by output from the output execution unit in accordance with a distance detected by the distance sensor, the collision risk notification unit may notify the user of the risk by output from the output execution unit disposed with respect to the user in a direction in which the object whose distance is detected by the distance sensor is present with respect to the user.

With this configuration, in the case of notifying the user of the risk of the collision between the user and the object outside the user by the output from the output execution unit in accordance with a distance detected by the distance sensor, the collision risk notification system according to the present invention notifies the user of the risk of the collision between the user and the object outside the user by the output from the output execution unit disposed with respect to the user in the direction in which the object whose distance is detected by the distance sensor is present with respect to the user, so that it is possible to make the user easily recognize in which direction with respect to the user the object that is at the risk of collision with the user is present.

In the collision risk notification system according to the present invention, the output execution unit may include a vibration output unit that executes output of vibration as the output to be recognized by the user by a method other than the method through the vision of the user.

With this configuration, the collision risk notification system according to the present invention executes the output of vibration as the output to be recognized by the user by a method other than the method through the vision of the user, so that it is possible to make the user easily recognize the risk of the collision between the user and the object outside the user.

In the collision risk notification system according to the present invention, the output execution unit includes a sound output unit that executes output of sound as output to be recognized by the user by a method other than the method through the vision of the user, and the collision risk notification unit may cause a distance detected by the distance sensor, at which notification of the risk by output of sound from the sound output unit starts, to be shorter than a distance detected by the distance sensor, at which notification of the risk by output of vibration from the vibration output unit starts.

With this configuration, the collision risk notification system according to the present invention causes a distance detected by the distance sensor, at which notification of the risk of the collision between the user and the object outside the user by the output of sound from the sound output unit starts, to be shorter than a distance detected by the distance sensor, at which notification of the risk of the collision between the user and the object outside the user by the output of vibration from the vibration output unit starts, so that it is possible to make the user recognize in a stepwise manner the risk of the collision between the user and the object outside the user.

The collision risk notification system according to the present invention may include an attached portion attached to a torso of the user, and the vibration output unit may be disposed on the attached portion.

With this configuration, in the collision risk notification system according to the present invention, the vibration output unit is disposed on the torso of the user via the attached portion, so that the possibility that the vibration caused by the vibration output unit gives discomfort to the user can be reduced as compared with the configuration in which the vibration output unit is disposed on the head of the user.

The collision risk notification system according to the present invention may include an attached portion attached to the user, and the distance sensor and the output execution unit may be disposed on the same attached portion.

With this configuration, in the collision risk notification system according to the present invention, the distance sensor and the output execution unit are arranged on the same attached portion, so that the work of attaching the distance sensor and the output execution unit to the user becomes easy.

The collision risk notification system of the present invention can improve the ability to make a user recognize the risk of a collision between the user and an object outside the user as compared with the related art.

### BRIEF DESCRIPTION OF THE DRAWINGS

FIG. 1A is a front view of a collision risk notification device according to an embodiment of the present invention in a state of being attached to a user; FIG. 1B is a rear view of the collision risk notification device illustrated in FIG. 1A in the state of being attached to the user;

FIG. 2A is a left side view of the collision risk notification device illustrated in FIGS. 1A and 1B in the state of being attached to the user; FIG. 2B is a right side view of the collision risk notification device illustrated in FIGS. 1A and 1B in the state of being attached to the user;

FIG. 3 is a top view of the collision risk notification device illustrated in FIGS. 1A and 1B in the state of being attached to the user;

FIG. 4 is a block diagram of the collision risk notification device illustrated in FIGS. 1A and 1B;

FIG. 5 is a flowchart of an operation of the collision risk notification device illustrated in FIGS. 1A and 1B in a case where the risk of a collision between the user and an object outside the user is notified to the user;

FIG. 6A is a front view of a collision risk notification system different from the example illustrated in FIGS. 1A and 1B in a state of being attached to the user; FIG. 6B is a rear view of the collision risk notification system illustrated in FIG. 6A in the state of being attached to the user;

FIG. 7A is a left side view of the collision risk notification system illustrated in FIGS. 6A and 6B in the state of being attached to the user; FIG. 7B is a right side view of the collision risk notification system illustrated in FIGS. 6A and 6B in the state of being attached to the user; and

FIG. 8 is a top view of the collision risk notification system illustrated in FIGS. 6A and 6B in the state of being attached to the user.

### DETAILED DESCRIPTION

Hereinafter, embodiments of the present invention will be described with reference to the drawings.

First, a configuration of a collision risk notification device as a collision risk notification system according to an embodiment of the present invention will be described.

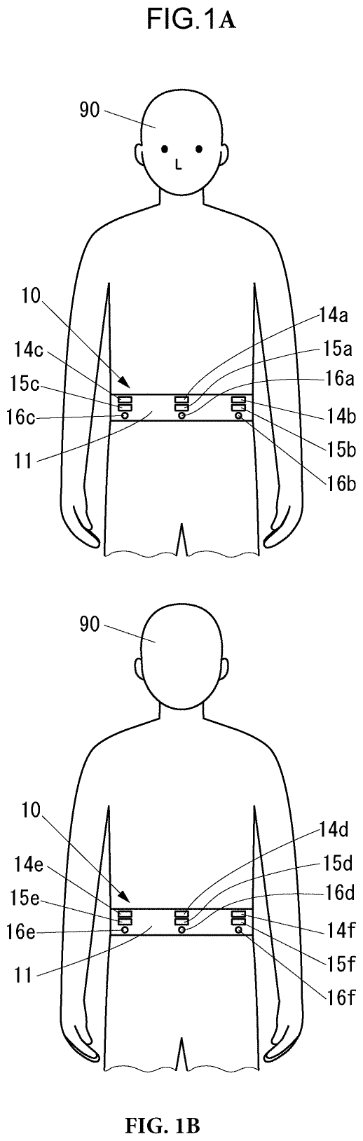

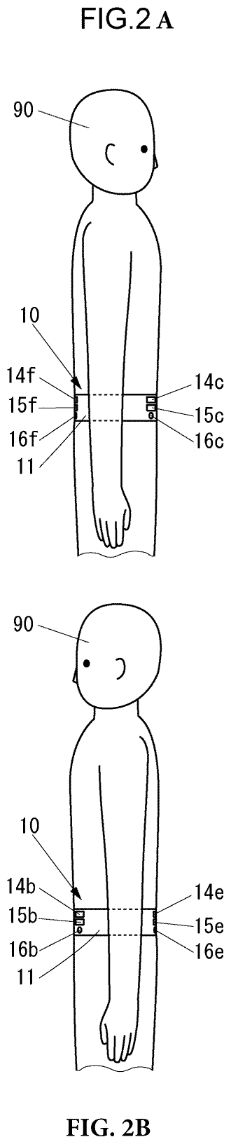

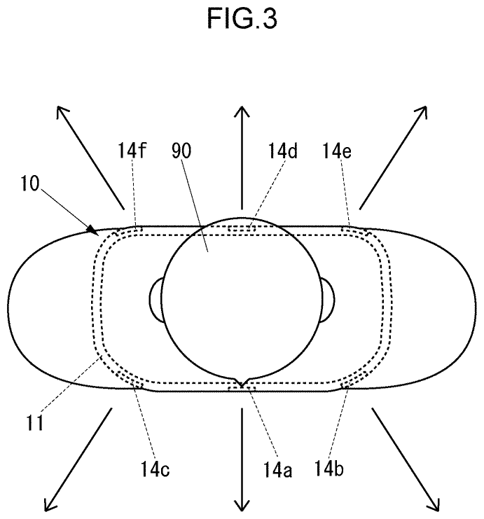

FIG. 1A is a front view of a collision risk notification device 10 according to the present embodiment in a state of being attached to a user 90. FIG. 1B is a rear view of the collision risk notification device 10 in the state of being attached to the user 90. FIG. 2A is a left side view of the collision risk notification device 10 in the state of being attached to the user 90. FIG. 2B is a right side view of the collision risk notification device 10 in the state of being attached to the user 90. FIG. 3 is a top view of the collision risk notification device 10 in the state of being attached to the user 90.

When the user 90 illustrated in FIGS. 1A to 3 moves, the user 90 may collide with an object outside the user 90, such as a power pole or a wall. In addition, even if the user 90 himself/herself does not move, the object outside the user 90 may move to collide with the user 90. The collision risk notification device 10 is a device that notifies the user of the risk of a collision (hereinafter, referred to as “collision risk”) between the user 90 and the object outside the user 90.

The collision risk notification device 10 includes a belt 11 as an attached portion to be attached to the user 90 by being wound around the waist of the user 90.

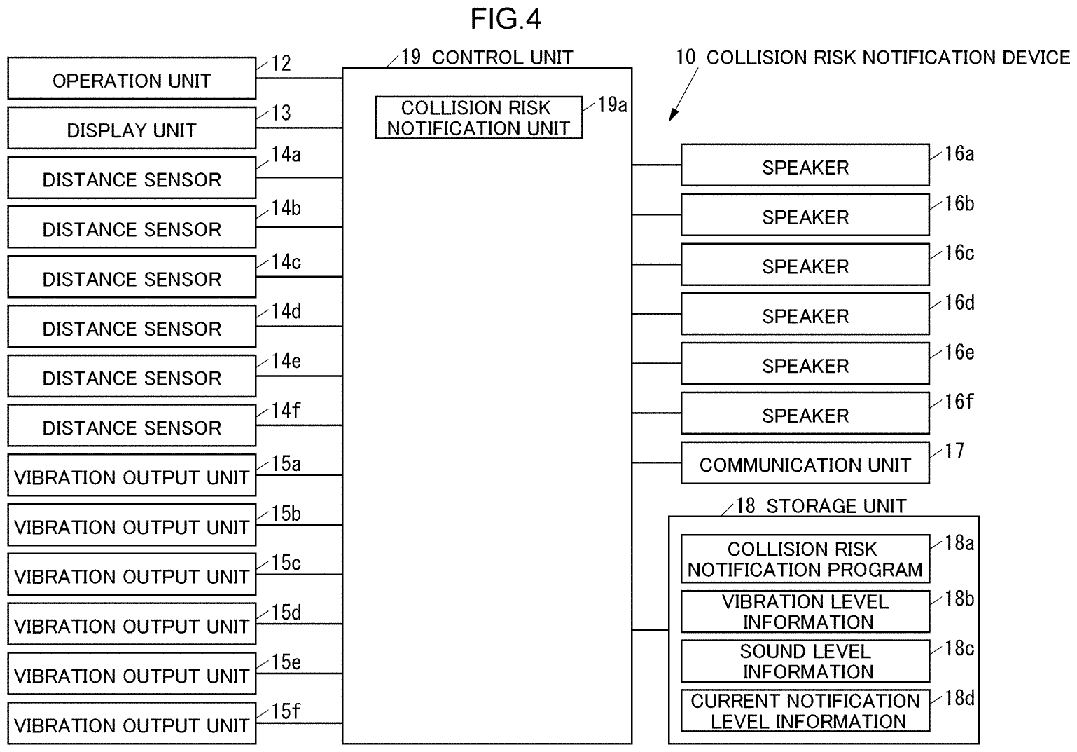

FIG. 4 is a block diagram of the collision risk notification device 10.

As illustrated in FIGS. 1A to 4, the collision risk notification device 10 includes, on the belt 11, an operation unit 12 that is an operation device such as a button to which various operations are input, and a display unit 13 that is a display device such as a liquid crystal display (LCD) for displaying various information. The operation unit 12 and the display unit 13 may be disposed on at least one of the left side and the right side of the user 90 where distance sensors 14a to 14f to be described later are not disposed.

The collision risk notification device 10 includes the distance sensor 14a that is disposed at the center on the front side of the user 90 and detects the distance to an object present in a front direction in a non-contact manner, the distance sensor 14b that is disposed on the left front side of the user 90 and detects the distance to an object present in a left front direction in a non-contact manner, the distance sensor 14c that is disposed on the right front side of the user 90 and detects the distance to an object present in a right front direction in a non-contact manner, the distance sensor 14d that is disposed at the center on the rear side of the user 90 and detects a distance to an object present in a rear direction in a non-contact manner, the distance sensor 14e that is disposed on the left rear side of the user 90 and detects the distance to an object present in a left rear direction in a non-contact manner, and the distance sensor 14f that is disposed on the right rear side of the user 90 and detects the distance to an object present in a right rear direction in a non-contact manner. The distance sensors 14a to 14f are arranged on the belt 11, and are attached to the user 90 via the belt 11.

As a method of detecting the distance to a target object by the distance sensors 14a to 14f, any known method can be adopted. For example, the distance sensors 14a to 14f may detect the distance between each of the distance sensors 14a to 14f themselves and the target object in accordance with the time from when laser light is emitted toward the target object to when the laser light is reflected by the target object and returns.

Note that, since the left arm of the user 90 is present on the left side of the belt 11 in most cases, even if the collision risk notification device 10 includes, on the belt 11, a distance sensor that is disposed on the left side of the user 90 and detects the distance to an object present in the left direction, this distance sensor often detects the distance to the left arm of the user 90. Therefore, the collision risk notification device 10 does not need to include the distance sensor that is disposed on the left side of the user 90 and detects the distance to the object present in the left direction. Similarly, the collision risk notification device 10 does not need to include a distance sensor that is disposed on the right side of the user 90 and detects the distance to an object present in the right direction.

The collision risk notification device 10 includes a vibration output unit 15a that is disposed at the center on the front side of the user 90 and executes output of vibration, a vibration output unit 15b that is disposed on the left front side of the user 90 and executes the output of vibration, a vibration output unit 15c that is disposed on the right front side of the user 90 and executes the output of vibration, a vibration output unit 15d that is disposed at the center on the rear side of the user 90 and executes the output of vibration, a vibration output unit 15e that is disposed on the left rear side of the user 90 and executes the output of vibration, and a vibration output unit 15f that is disposed on the right rear side of the user 90 and executes the output of vibration. The vibration output units 15a to 15f are arranged on the belt 11, and are attached to the user 90 via the belt 11. The vibration output units 15a to 15f execute the output of vibration as output to be recognized by the user 90 by a method other than a method through the vision of the user 90. That is, the vibration output units 15a to 15f are output execution units that execute output to be recognized by the user 90 by a method other than the method through the vision of the user 90.

As a method of generating vibration by the vibration output units 15a to 15f, any known method can be adopted. For example, the vibration output units 15a to 15f may be eccentric rotating mass (ERM) vibration motors.

The vibration output unit 15a is a vibration output unit corresponding to the distance sensor 14a. Similarly, the vibration output units 15b, 15c, 15d, 15e, and 15f are vibration output units corresponding to the distance sensors 14b, 14c, 14d, 14e, and 14f, respectively.

The collision risk notification device 10 includes a speaker 16a as a sound output unit that is disposed at the center on the front side of the user 90 and executes output of sound, a speaker 16b as a sound output unit that is disposed on the left front side of the user 90 and executes the output of sound, a speaker 16c as a sound output unit that is disposed on the right front side of the user 90 and executes the output of sound, a speaker 16d as a sound output unit that is disposed at the center on the rear side of the user 90 and executes the output of sound, a speaker 16e as a sound output unit that is disposed on the left rear side of the user 90 and executes the output of sound, and a speaker 16f as a sound output unit that is disposed on the right rear side of the user 90 and executes the output of sound. The speakers 16a to 16f are arranged on the belt 11, and are attached to the user 90 via the belt 11. The speakers 16a to 16f execute the output of sound as output to be recognized by the user 90 by a method other than the method through the vision of the user 90. That is, the speakers 16a to 16f are output execution units that execute output to be recognized by the user 90 by a method other than the method through the vision of the user 90.

The speaker 16a is a speaker corresponding to the distance sensor 14a. Similarly, the speakers 16b, 16c, 16d, 16e, and 16f are speakers corresponding to the distance sensors 14b, 14c, 14d, 14e, and 14f, respectively.

The collision risk notification device 10 includes, on the belt 11, a communication unit 17 that is a communication device that communicates with an external device via a network such as a local area network (LAN) or the Internet or directly in a wired or wireless manner without the network, a storage unit 18 that is a nonvolatile storage device such as a semiconductor memory for storing various information, and a control unit 19 that controls the entire collision risk notification device 10.

The storage unit 18 stores a collision risk notification program 18a for notifying the user of a collision risk. For example, the collision risk notification program 18a may be installed in the collision risk notification device 10 at the manufacturing stage of the collision risk notification device 10, may be additionally installed in the collision risk notification device 10 from an external storage medium such as a universal serial bus (USB) memory, or may be additionally installed in the collision risk notification device 10 from the network.

The storage unit 18 stores vibration level information 18b indicating the correspondence relationship between the level (hereinafter referred to as a “notification level”) of the notification of the collision risk and the intensity of vibration output by the vibration output units 15a to 15f in each of distance ranges detected by the distance sensors 14a to 14f Here, the notification level includes, for example, three levels of high, medium, and low. The distance range in the vibration level information 18b includes, for example, three levels of a range of 0 m or more and 0.5 m or less, a range of more than 0.5 m and 1 m or less, and a range of more than 1 m and 3 m or less. In the vibration level information 18b, the distance range and the intensity of vibration output by the vibration output units 15a to 15f are associated with each other in such a manner that with the same notification level, the larger the intensity of vibration output by the vibration output units 15a to 15f, the shorter the distance. In the vibration level information 18b, the notification level and the intensity of vibration output by the vibration output units 15a to 15f are associated with each other in such a manner that with the same distance range, the higher the notification level, the larger the intensity of vibration output by the vibration output units 15a to 15f.

The storage unit 18 stores sound level information 18c indicating the correspondence relationship between the notification level and the loudness of the sound output from the speakers 16a to 16f in each of the distance ranges detected by the distance sensors 14a to 14f. The distance range in the sound level information 18c includes, for example, three levels of a range of 0 m or more and 0.5 m or less, a range of more than 0.5 m and 1 m or less, and a range of more than 1 m and 3 m or less. In the sound level information 18c, the distance range and the loudness of the sound output from the speakers 16a to 16f are associated with each other in such a manner that with the same notification level, the larger the loudness of the sound output from the speakers 16a to 16f, the shorter the distance. In the sound level information 18c, the notification level and the loudness of the sound output from the speakers 16a to 16f are associated with each other in such a manner that with the same distance range, the higher the notification level, the larger the loudness of the sound output from the speakers 16a to 16f.

The storage unit 18 stores current notification level information 18d indicating the current notification level.

The control unit 19 includes, for example, a central processing unit (CPU), a read only memory (ROM) that stores programs and various data, and a random access memory (RAM) as a memory used as a work area of the CPU of the control unit 19. The CPU of the control unit 19 executes a program stored in the storage unit 18 or the ROM of the control unit 19.

The control unit 19 executes the collision risk notification program 18a to implement a collision risk notification unit 19a that notifies the user of the collision risk.

Next, an operation of the collision risk notification device 10 will be described.

First, an operation of the collision risk notification device 10 in a case where the notification level is changed will be described.

The user can instruct the collision risk notification device 10 to change the notification level via the operation unit 12. When instructed to change the notification level, the collision risk notification unit 19a writes the notification level instructed via the operation unit 12 as the changed notification level in the current notification level information 18d.

Next, an operation of the collision risk notification device 10 in a case where the collision risk is notified to the user will be described.

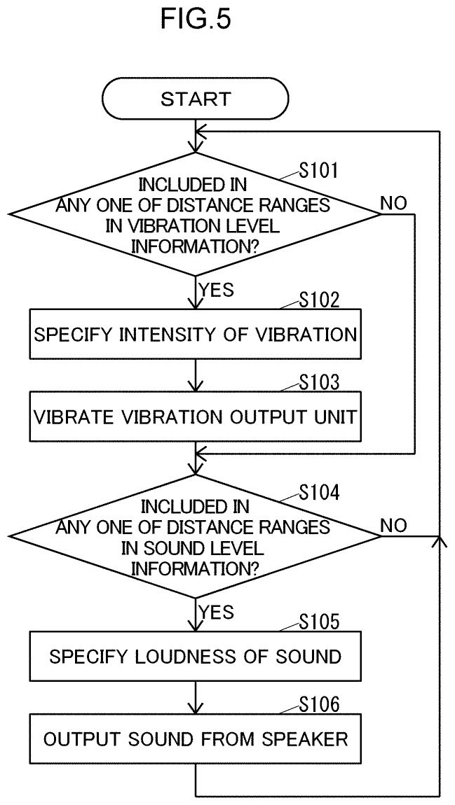

FIG. 5 is a flowchart of the operation of the collision risk notification device 10 in a case where the collision risk is notified to the user.

As illustrated in FIG. 5, the collision risk notification unit 19a determines whether or not the distance detected by any one of the distance sensors 14a to 14f is included in any one of the distance ranges in the vibration level information 18b (S101). Here, among the distance sensors 14a to 14f, the distance sensor in which the detected distance is included in the distance range in the vibration level information 18b is referred to as a target distance sensor in the processes of S102 to S103.

When determining in S101 that the distance detected by any one of the distance sensors 14a to 14f is included in any one of the distance ranges in the vibration level information 18b, the collision risk notification unit 19a specifies, in each target distance sensor, the intensity of vibration associated in the vibration level information 18b with the notification level in the current notification level information 18d and the distance range in the vibration level information 18b including the distance detected by the target distance sensor (S102).

Next, the collision risk notification unit 19a vibrates the vibration output unit corresponding to the target distance sensor with the intensity specified in the target distance sensor in S102 (S103). For example, in a case where the target distance sensor is the distance sensor 14a, the collision risk notification unit 19a vibrates the vibration output unit 15a corresponding to the distance sensor 14a, which is the target distance sensor, with the intensity specified in the distance sensor 14a in S102. Similarly, in a case where the target distance sensor is the distance sensor 14d, the collision risk notification unit 19a vibrates the vibration output unit 15d corresponding to the distance sensor 14d, which is the target distance sensor, with the intensity specified in the distance sensor 14d in S102.

When the collision risk notification unit 19a determines in S101 that the distance detected by each of the distance sensors 14a to 14f is not included in any one of the distance ranges in the vibration level information 18b, or when the process of S103 ends, the collision risk notification unit 19a determines whether or not the distance detected by any one of the distance sensors 14a to 14f is included in any one of the distance ranges in the sound level information 18c (S104). Here, among the distance sensors 14a to 14f, the distance sensor in which the detected distance is included in the distance range in the sound level information 18c is referred to as a target distance sensor in the processes of S105 to S106.

When determining in S104 that the distance detected by any one of the distance sensors 14a to 14f is included in any one of the distance ranges in the sound level information 18c, the collision risk notification unit 19a specifies, in each target distance sensor, the loudness of sound associated in the sound level information 18c with the notification level in the current notification level information 18d and the distance range in the sound level information 18c including the distance detected by the target distance sensor (S105).

Next, the collision risk notification unit 19a outputs sound with the loudness specified in the target distance sensor in S105 from the speaker corresponding to the target distance sensor (S106). For example, in a case where the target distance sensor is the distance sensor 14a, the collision risk notification unit 19a outputs sound with the loudness specified in the distance sensor 14a in S105 from the speaker 16a corresponding to the distance sensor 14a, which is the target distance sensor. Similarly, in a case where the target distance sensor is the distance sensor 14d, the collision risk notification unit 19a outputs sound with the loudness specified in the distance sensor 14d in S105 from the speaker 16d corresponding to the distance sensor 14d, which is the target distance sensor.

When the collision risk notification unit 19a determines in S104 that the distance detected by each of the distance sensors 14a to 14f is not included in any one of the distance ranges in the sound level information 18c, or when the process of S106 ends, the collision risk notification unit 19a performs the process of S101.

As described above, the collision risk notification device 10 notifies the user 90 of the collision risk by the output to be recognized by a method other than the method through the vision of the user 90 in accordance with the distance to the object outside the user 90 detected by the distance sensors 14a to 14f in a non-contact manner. That is, the collision risk notification device 10 notifies the user of the collision risk by the output of vibration (S103) or by the output of sound (S106) in accordance with the distance to the object outside the user 90 detected by the distance sensors 14a to 14f Therefore, for example, even in a case where it is difficult for the user 90 to visually recognize the object outside the user 90, the collision risk notification device 10 can improve the ability to make the user 90 recognize the collision risk as compared with the related art. Here, the case where it is difficult for the user 90 to visually recognize the object outside the user 90 is, for example, a case where the user 90 is reading a book, the user 90 is looking at a screen of a mobile device, the user 90 is absent-minded, or the user 90 is a visually handicapped person.

Since the collision risk notification device 10 executes the output of vibration as the output to be recognized by the user 90 by a method other than the method through the vision of the user 90, for example, even in a case where it is difficult for the user 90 to recognize the output of sound, the collision risk notification device 10 can make the user 90 easily recognize the collision risk. The case where it is difficult for the user 90 to recognize the output of sound is, for example, a case where the user 90 wears earphones, headphones, or earplugs, the user 90 is in conversation, the surroundings of the user 90 are noisy, or the user 90 is a hearing impaired person.

Since the collision risk notification device 10 executes the output of sound as the output to be recognized by the user 90 by a method other than the method through the vision of the user 90, for example, even in a case where it is difficult for the user 90 to recognize the output of vibration, the collision risk notification device 10 can make the user 90 easily recognize the collision risk.

In the collision risk notification device 10, the vibration level information 18b and the sound level information 18c may be set in such a manner that the distance detected by the distance sensor, at which notification of the collision risk by output of sound from the speaker starts, is shorter than the distance detected by the distance sensor, at which notification of the collision risk by output of vibration from the vibration output unit starts. In a case where the distance detected by the distance sensor, at which the notification of the collision risk by the output of sound from the speaker starts, is shorter than the distance detected by the distance sensor, at which the notification of the collision risk by the output of vibration from the vibration output unit starts, the collision risk notification device 10 can make the user 90 recognize the collision risk in a stepwise manner.

In the case of notifying the user of the collision risk by the output of vibration (YES in S101), the collision risk notification device 10 notifies the user of the collision risk in a stepwise manner (S102 to S103) by changing the mode of the output of vibration in a stepwise manner in accordance with the distance detected by the distance sensors 14a to 14f, and thus the collision risk notification device 10 can make the user recognize the collision risk in a stepwise manner.

In the present embodiment, the collision risk notification device 10 notifies the user 90 of the distance to an object outside the user 90 by the intensity of vibration. However, the collision risk notification system may notify the user 90 of the distance to the object outside the user 90 by a vibration mode other than the intensity of vibration instead of the intensity of vibration or in addition to the intensity of vibration. For example, the collision risk notification system may notify the user 90 of the distance to the object outside the user 90 by the frequency of vibration. In a case where the collision risk notification system notifies the user 90 of the distance to the object outside the user 90 by the frequency of vibration, for example, the vibration level information 18b may be set in such a manner that the higher the frequency of vibration, the shorter the distance to the object outside the user 90.

In the case of notifying the user of the collision risk by the output of sound (YES in S104), the collision risk notification device 10 notifies the user of the collision risk in a stepwise manner (S105 to S106) by changing the mode of the output of sound in a stepwise manner in accordance with the distance detected by the distance sensors 14a to 14f, and thus the collision risk notification device 10 can make the user recognize the collision risk in a stepwise manner.

In the present embodiment, the collision risk notification device 10 notifies the user 90 of the distance to an object outside the user 90 by the loudness of sound. However, the collision risk notification system may notify the user 90 of the distance to the object outside the user 90 by a sound mode other than the loudness of sound instead of the loudness of sound or in addition to the loudness of sound. For example, the collision risk notification system may notify the user 90 of the distance to the object outside the user 90 by the frequency of sound, or by voice such as “There is an object in a range of 1 m to 3 m ahead.”. In a case where the collision risk notification system notifies the user 90 of the distance to the object outside the user 90 by the frequency of vibration, for example, the sound level information 18c may be set in such a manner that the higher the frequency of sound, the shorter the distance to the object outside the user 90.

In the case of notifying the user of the collision risk by the output of vibration from the vibration output unit in accordance with the distance detected by the distance sensor (YES in S101), the collision risk notification device 10 notifies the user of the collision risk by the output of vibration from the vibration output unit disposed with respect to the user 90 in the direction in which the object whose distance is detected by the distance sensor is present with respect to the user 90 (S103), and thus, the collision risk notification device 10 can make the user 90 easily recognize in which direction with respect to the user 90 the object that is at the risk of collision with the user 90 is present.

Similarly, in the case of notifying the user of the collision risk by the output of sound from the speaker in accordance with the distance detected by the distance sensor (YES in S104), the collision risk notification device 10 notifies the user of the collision risk by the output of sound from the speaker disposed with respect to the user 90 in the direction in which the object whose distance is detected by the distance sensor is present with respect to the user 90 (S106), and thus, the collision risk notification device 10 can make the user 90 easily recognize in which direction with respect to the user 90 the object that is at the risk of collision with the user 90 is present.

Note that, in the present embodiment, in the case of notifying the user of the collision risk by the output of sound from the speaker in accordance with the distance detected by the distance sensor, the collision risk notification device 10 notifies the user of the collision risk by the output of sound from a speaker disposed with respect to the user 90 in the direction in which the object whose distance is detected by the distance sensor is present with respect to the user 90. However, in the case of notifying the user of the collision risk by the output of sound from the speaker in accordance with the distance detected by the distance sensor, the collision risk notification device 10 may notify the user 90 of in which direction with respect to the user 90 the object that is at the risk of collision with the user 90 is present, for example, by the contents of the sound output such as “There is an object in a range of 1 m to 3 m ahead.”. In the case of notifying the user 90 of in which direction with respect to the user 90 the object that is at the risk of collision with the user 90 is present by the contents of the sound output, the collision risk notification device 10 may include only one speaker.

In the collision risk notification device 10, since the vibration output units 15a to 15f are arranged on the waist, that is, the torso of the user 90 via the belt 11, the possibility that the vibration caused by the vibration output units 15a to 15f gives discomfort to the user 90 can be reduced as compared with the configuration in which the vibration output units 15a to 15f are arranged on the head of the user 90.

In the present embodiment, the vibration output units 15a to 15f are attached to the waist of the user 90 via the belt 11. However, the vibration output units 15a to 15f may be attached to parts other than the waist of the user 90. For example, the vibration output units 15a to 15f may be attached to any one of the head, the neck, and the torso other than the waist of the user 90.

Similarly, in the present embodiment, the speakers 16a to 16f are attached to the waist of the user 90 via the belt 11. However, the speakers 16a to 16f may be attached to parts other than the waist of the user 90. For example, the speakers 16a to 16f may be attached to any one of the head, the neck, and the torso other than the waist of the user 90.

Similarly, in the present embodiment, the distance sensors 14a to 14f are attached to the waist of the user 90 via the belt 11. However, the distance sensors 14a to 14f may be attached to parts other than the waist of the user 90. For example, the distance sensors 14a to 14f may be attached to any one of the head, the neck, and the torso other than the waist of the user 90.

The collision risk notification system includes the distance sensors 14a to 14f. However, the collision risk notification system does not need to include at least one of the distance sensors 14a to 14f, or may newly include a distance sensor other than the distance sensors 14a to 14f. For example, the collision risk notification device 10 may include only the distance sensor 14a as the distance sensor, and may include only the vibration output unit 15a as the vibration output unit.

In the collision risk notification device 10, since the distance sensors 14a to 14f, the vibration output units 15a to 15f, and the speakers 16a to 16f are arranged on the same belt 11, the work of attaching the distance sensors 14a to 14f, the vibration output units 15a to 15f, and the speakers 16a to 16f to the user 90 becomes easy.

In the present embodiment, the collision risk notification device 10 can change the notification level in the current notification level information 18d via the operation unit 12. Similarly, the collision risk notification device 10 may change each of the vibration level information 18b and the sound level information 18c, such as the distance range in each of the vibration level information 18b and the sound level information 18c via the operation unit 12.

In the present embodiment, the collision risk notification device 10 can change the notification level in the current notification level information 18d via the operation unit 12. However, the collision risk notification device 10 may change the notification level in the current notification level information 18d and each of the vibration level information 18b and the sound level information 18c from an electronic device outside the collision risk notification device 10 such as a personal computer (PC) or a smartphone via the communication unit 17. In the collision risk notification device 10, in a case where the notification level in the current notification level information 18d and each of the vibration level information 18b and the sound level information 18c can be changed from the external electronic device via the communication unit 17, the contents that can be changed from the external electronic device via the communication unit 17 may be more detailed than the contents that can be changed via the operation unit 12.

The collision risk notification device 10 has three notification levels in the present embodiment. However, any number of notification levels other than three can be used. For example, the number of notification levels may be four or more, two, or one.

In the present embodiment, the collision risk notification device 10 stores the collision risk notification program 18a, the vibration level information 18b, the sound level information 18c, and the current notification level information 18d in the storage unit 18 on the belt 11. However, in the collision risk notification device 10, at least a part of the information stored in the storage unit 18 may be stored in an electronic device disposed at a place away from the user 90. In a case where at least a part of the information stored in the storage unit 18 is stored in an electronic device disposed at a place away from the user 90, the collision risk notification device 10 can acquire the information stored in the electronic device via the communication unit 17.

In the present embodiment, the collision risk notification device 10 implements the collision risk notification unit 19a by the control unit 19 on the belt 11. However, in the collision risk notification device 10, at least a part of the function of the collision risk notification unit 19a may be implemented by an electronic device such as a cloud server disposed at a place away from the collision risk notification device 10. In a case where at least a part of the function of the collision risk notification unit 19a is implemented by an electronic device disposed at a place away from the collision risk notification device 10, the collision risk notification device 10 can transmit and receive information to and from the electronic device via the communication unit 17. Note that, in a case where at least a part of the function of the collision risk notification unit 19a is implemented by an electronic device disposed at a place away from the collision risk notification device 10, the electronic device and the collision risk notification device 10 constitute a collision risk notification system.

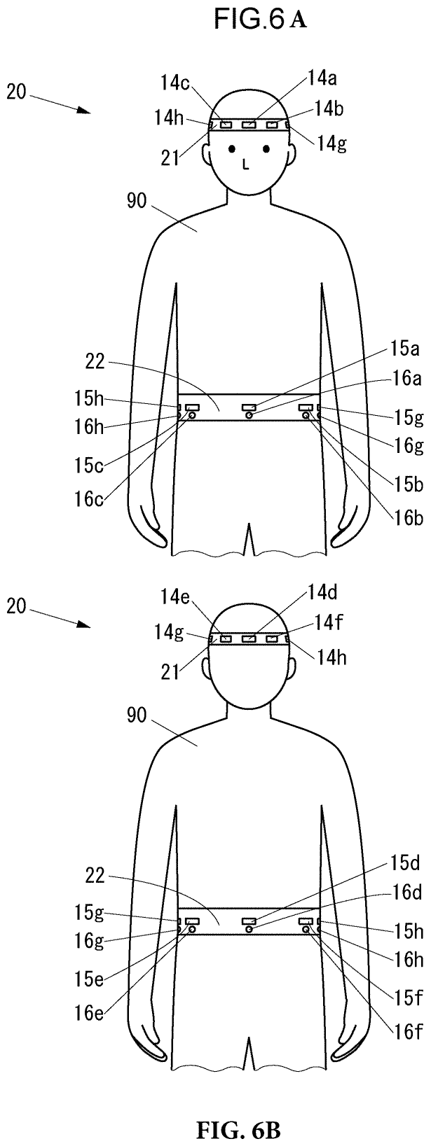

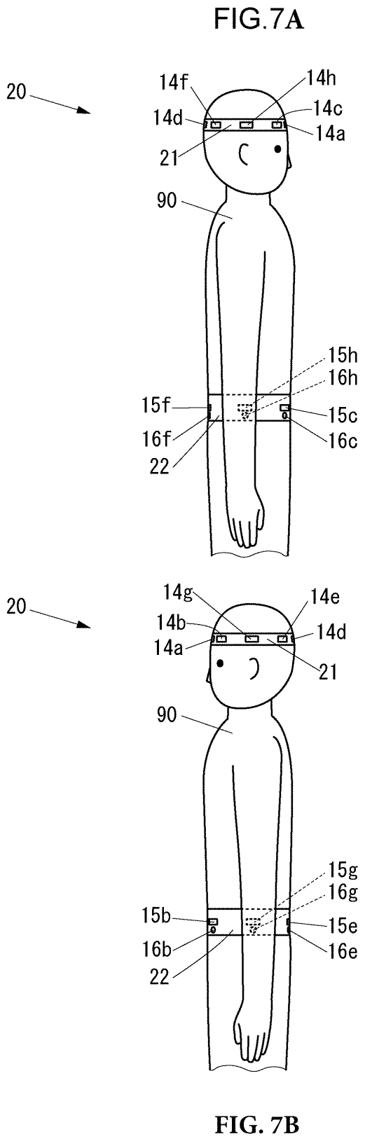

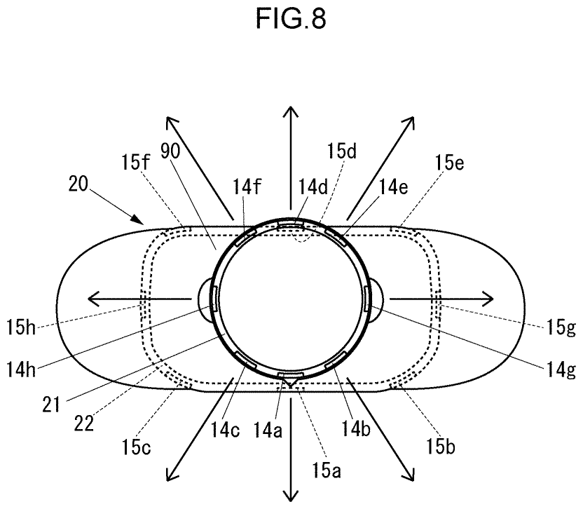

FIG. 6A is a front view of a collision risk notification system 20 different from the example illustrated in FIGS. 1A and 1B in a state of being attached to the user 90. FIG. 6B is a rear view of the collision risk notification system 20 in the state of being attached to the user 90. FIG. 7A is a left side view of the collision risk notification system 20 in the state of being attached to the user 90. FIG. 7B is a right side view of the collision risk notification system 20 in the state of being attached to the user 90. FIG. 8 is a top view of the collision risk notification system 20 in the state of being attached to the user 90.

In the present embodiment, in the collision risk notification device 10, the distance sensors 14a to 14f, the vibration output units 15a to 15f, and the speakers 16a to 16f are attached to the waist of the user 90. However, in the collision risk notification system, the distance sensors 14a to 14f, the vibration output units 15a to 15f, and the speakers 16a to 16f may be separately attached to a plurality of parts of the user 90. For example, as illustrated in FIGS. 6A to 8, the collision risk notification system may be the collision risk notification system 20 in which the distance sensors 14a to 14f are arranged on a belt 21 attached to the user 90 by being wound around the head of the user 90, and the vibration output units 15a to 15f and the speakers 16a to 16f are arranged on a belt 22 as the attached portion attached to the user 90 by being wound around the waist of the user 90.

The collision risk notification system 20 includes a distance sensor 14g that is disposed on the left side of the head of the user 90 and detects the distance to an object present in the left direction, a distance sensor 14h that is disposed on the right side of the head of the user 90 and detects the distance to an object present in the right direction, a vibration output unit 15g that is disposed on the left side of the waist of the user 90 and executes output of vibration, a vibration output unit 15h that is disposed on the right side of the waist of the user 90 and executes the output of vibration, a speaker 16g that is disposed on the left side of the waist of the user 90 and executes output of sound, and a speaker 16h that is disposed on the right side of the waist of the user 90 and executes the output of sound. The distance sensors 14g and 14h are arranged on the belt 21. The vibration output units 15g and 15h and the speakers 16g and 16h are arranged on the belt 22.

The vibration output unit 15g is a vibration output unit corresponding to the distance sensor 14g. The vibration output unit 15h is a vibration output unit corresponding to the distance sensor 14h. The speaker 16g is a speaker corresponding to the distance sensor 14g. The speaker 16h is a speaker corresponding to the distance sensor 14h.

The configuration of the collision risk notification system 20 is similar to the configuration of the collision risk notification device 10 except for the configuration described above.

In the present embodiment, the collision risk notification device 10 executes the output of vibration and the output of sound as output to be recognized by the user 90 by a method other than the method through the vision of the user 90. However, the collision risk notification device 10 may execute only one of the output of vibration and the output of sound as the output to be recognized by the user 90 by a method other than the method through the vision of the user 90.

In the present embodiment, the output execution unit that executes the output to be recognized by user 90 by a method other than the method through the vision of user 90 executes the output of vibration and the output of sound. However, the output execution unit may execute output that is neither the output of vibration nor the output of sound as the output to be recognized by the user 90 by a method other than the method through the vision of the user 90. For example, the output execution unit may execute heating or cooling as the output to be recognized by the user 90 by a method other than the method through the vision of the user 90.

What is claimed is:

1. A collision risk notification system that notifies a user of a risk of a collision between the user and an object outside the user, the collision risk notification system comprising:
an attached portion that is attached to a torso of the user;
a distance sensor that is disposed on the attached portion and detects a distance to the object in a non-contact manner;
an output execution unit that executes output to be recognized by the user by a method other than a method through vision of the user; and
a collision risk notification unit that notifies the user of the risk by output from the output execution unit in accordance with a distance detected by the distance sensor, wherein
the collision risk notification system comprising:
the distance sensor that detects a distance to the object present in a front direction of the user in a non-contact manner; and
the distance sensor that detects a distance to the object present in a rear direction of the user in a non-contact manner, and
the collision risk notification system not comprising at least one of:
the distance sensor that detects a distance to the object present in a left direction of the user in a non-contact manner; or
the distance sensor that detects a distance to the object present in a right direction of the user in a non-contact manner.

2. The collision risk notification system according to claim 1, wherein the output execution unit is attached to the user.

3. The collision risk notification system according to claim 2, wherein the output execution unit is disposed on the attached portion.

4. The collision risk notification system according to claim 1, wherein the output execution unit includes a vibration output unit that executes output of vibration as output to be recognized by the user by a method other than a method through vision of the user.

5. The collision risk notification system according to claim 4, wherein the vibration output unit is disposed on the attached portion.

6. The collision risk notification system according to claim 1, wherein
the output execution unit includes
a vibration output unit that executes output of vibration as output to be recognized by the user by a method other than a method through vision of the user, and
a sound output unit that executes output of sound as output to be recognized by the user by a method other than the method through vision of the user, and
the collision risk notification unit causes a distance detected by the distance sensor, at which notification of the risk by output of sound from the sound output unit starts, to be shorter than a distance detected by the distance sensor, at which notification of the risk by output of vibration from the vibration output unit starts.

7. The collision risk notification system according to claim 1, wherein the collision risk notification unit notifies the user of the risk in a stepwise manner by changing a mode of output from the output execution unit in a stepwise manner in accordance with a distance detected by the distance sensor when notifying the user of the risk by the output from the output execution unit.

8. The collision risk notification system according to claim 1, wherein in a case where the collision risk notification unit notifies the user of the risk by output from the output execution unit in accordance with a distance detected by the distance sensor, the collision risk notification unit notifies the user of the risk by output from the output execution unit disposed with respect to the user in a direction in which the object whose distance is detected by the distance sensor is present with respect to the user.
